(19) United States
(12) Patent Application Publication
(10) Pub. No.: US 2005/0047041 A1
(43) Pub. Date: Mar. 3, 2005

(54) Over-current protection device

(76) Inventors: Yun-Ching Ma, Pingtung City (TW); Tong-Cheng Tsai, Tainan City (TW)

Correspondence Address: Harold V. Stotland, 42nd Floor, 55 East Monroe Street, Chicago, IL, 60603-5803, US

(21) Appl. No.: 10/878,915

(22) Filed: Jun. 28, 2004

(30) Foreign Application Priority Data
Aug. 27, 2003 (TW) 092123619

(51) Int. Cl. H02H 5/04

(52) U.S. Cl. 361/93.1

(57) ABSTRACT

An over-current protection device includes a first electrode layer, a second electrode layer and a polymeric current-sensitive layer sandwiched between the first and second electrode layers. The polymeric current-sensitive layer comprises 2-4% silicate flakes by weight, which is a nano-material of a thickness approximately 1 nanometer (nm) and a diameter between 100-500 nm.

### BACKGROUND OF THE INVENTION

(A) Field of the Invention

The present invention is related to an over-current protection device, more specifically, to an over-current protection device capable of retarding flame.

(B) Description of the Related Art

The resistance of a positive temperature coefficient (PTC) conductive material is sensitive to temperature variation, and can be kept extremely low at normal operation due to its low sensitivity to temperature variation so that the circuit can operate normally. However, if an over-current or an over-temperature event occurs, the resistance will immediately increase to a high resistance state (e.g., above 10⁴ ohm). Therefore, the over-current will be reversely eliminated and the objective to protect the circuit device can be achieved. Therefore, the PTC elements are incorporated into various circuit devices so as to avoid the damage caused by over-current.

Traditionally, a polymeric PTC element is essentially composed of polymer, carbon blacks, inorganic fillers and modifiers, wherein the carbon blacks are used for electrical conduction, the inorganic fillers are used as flame retardants, and the modifiers are used for increasing the bonding strength between materials.

Although aluminum hydroxide (Al(OH)₃) or magnesium hydroxide (Mg(OH)₂) can be added into PTC elements as flame retardant, high addition percentage, e.g., 60-65%, is needed to ensure the protection effect. This, however, will be harmful to the electrical characteristics and the mechanical strength of the PTC elements, so the tradeoff of adding flame retardant is hard to be overcome.

### SUMMARY OF THE INVENTION

The objective of the present invention is to provide an over-current protection device with superior flame retarding feature, with a view to applying for high voltage environments.

With the vigorous development of nano-materials, in addition to the applications for new fields, numerous existing products can also attain better performances thereby. Because the dimensions for nano-materials are tremendously decreased, the surface areas of the nano-materials, in contrast, are significantly increased per unit weight. Accordingly, the reaction effect, i.e., so-called quantum effect, can be increased. The nano-materials of extremely small dimensions are employed for an over-current protection device of the present invention, so as to magnify the effects of flame retardants.

An over-current protection device is disclosed, and it comprises a first electrode layer, a second electrode layer and a polymeric current-sensitive layer sandwiched between the first and second electrode layers. The polymeric current-sensitive layer comprises silicate flakes of 2-4% by weight, which is a nano-material of a thickness of approximately 1 nanometer (nm) and a diameter between 100-500 nm.

The polymeric current-sensitive layer further comprises polyethylene (PE) of 36-40%, carbon blacks of 24-29%, magnesium hydroxides of 20-24% and talc of 10-13% by weight, which are used for serving as a matrix, electrical conduction, retarding flame and material coupling, respectively.

By the addition of the silicate flakes, the effects of flame retardants can be enhanced, thereby the probability of damage of the over-current protection device can be diminished tremendously.

### BRIEF DESCRIPTION OF THE DRAWING

FIG. 1 is an illustration of the over-current protection device of the present invention.

### DETAILED DESCRIPTION OF THE INVENTION

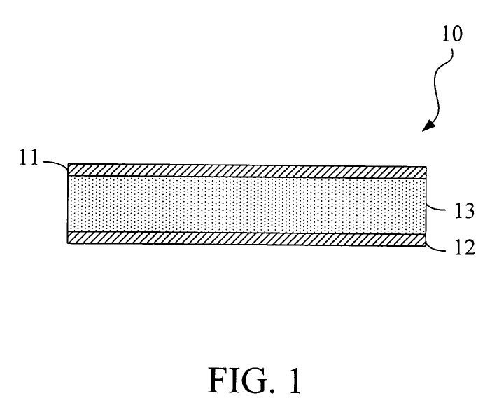

FIG. 1 illustrates an over-current protection device put forth in the present invention. An over-current protection device 10 comprises a first electrode layer 11, a second electrode layer 12 and a polymeric current-sensitive layer 13, where the polymeric current-sensitive layer 13 is sandwiched between the first and second electrode layers 11 and 12, i.e., the over-current protection device 10 is in the form of a lamination.

In the polymeric current-sensitive layer 13, polyethylene is chosen as a matrix material, carbon blacks are added for electrical conduction, magnesium hydroxides are employed as flame retardant, talc is employed as a modifier, and a nano-material “Nanofil 15” is added. Magnesium hydroxide is an inert material, so it has the capability to retard flame. The talc can increase the coupling effect between materials, so as to increase the bonding strength. In addition, talc comprises inert materials such as silicon oxide and magnesium oxide, so it can function as flame retardant also. The Nanofil 15, a nano-material produced by SUD-CHEMIE Inc., is powder-like in macro view, but is essentially composed of silicate flakes. Each silicate flake is of a diameter ranging from 100 to 500 nm and a thickness ranging from 0.7 to 1.3 nm, whereas density thereof is approximately 1.8 g/cm³. If the ratio of diameter to thickness is defined as an aspect ration, the aspect ratio of the silicate flake is between 100 and 500 nm.

Besides being of nano-order, the silicate flake has high aspect ratio, SO the interface surfaces between the silicate flakes are relatively large, thereby the effect to retard flame can be enhanced apparently.

Table 1 shows the weight ratios of ingredients and testing results of the over-current protection device 10 and two devices without adding Nanofil 15 (comparisons 1 and 2), wherein seven or eight testing samples of the over-current protection devices 10 are used, and five samples of each device without adding Nanofil 15 are employed for testing.

TABLE 1

| Composition | The present invention | Comparison 1 | Comparison 2 |
|---|---|---|---|
| PE | 37.34% | 38.90% | 39.43% |
| Carbon Black | 25.69% | 28.40% | 25.63% |
| Mg(OH)₂ | 22.93% | 21.51% | 22.40% |
| Talc | 11.04% | 11.19% | 12.54% |
| Nanofil 15 | 3.10% | 0% | 0% |

Testing Results

| Testing Conditions | Burning Damage Rate | | |
|---|---|---|---|
| 600 V/2.2 A/2 seconds | 0% | 20% | 80% |
| 600 V/3 A/1 second | 0% | 100% | 100% |
| 600 V/2.2 A/15 minutes | 0% | 100% | 100% |

In view of Table 1, an addition of approximately 3% Nanofil 15 can tremendously diminish the probability of burning damages of the devices, and the effect is more obvious for the conditions of high testing current and long testing time.

Based on experiments, 3% Nanofil 15 within the polymeric current-sensitive layer 13 by weight is the optimal ratio between 1% and 10%, and the addition of Nanofil 15 of 2-4% can effectively reduce the burning rate of the devices. Preferably, the polyethylene, carbon blacks, magnesium hydroxides and talc are of 36-40%, 24-29%, 20-24% and 10-13% by weight for application.

The above-described embodiments of the present invention are intended to be illustrative only. Numerous alternative embodiments may be devised by those skilled in the art without departing from the scope of the following claims.

1. An over-current protection device, comprising:
a first electrode layer;
a second electrode layer; and
a polymeric current-sensitive layer sandwiched between the first and second electrode layers and comprising silicate flakes of 2% to 4% by weight, wherein the silicate flake has a thickness in the range of 0.7 to 1.3 nm and a diameter in the range of 100 to 500 nm.

2. The over-current protection device of claim 1, wherein the silicate flakes are combined in the form of powders.

3. The over-current protection device of claim 1, wherein the silicate flake has a density substantially equal to 1.8 g/cm³.

4. The over-current protection device of claim 1, wherein the polymeric current-sensitive layer further comprises polyethylene of 36% to 40% by weight.

5. The over-current protection device of claim 1, wherein the polymeric current-sensitive layer further comprises carbon blacks of 24% to 29% by weight.

6. The over-current protection device of claim 1, wherein the polymeric current-sensitive layer further comprises magnesium hydroxides of 20% to 24% by weight.

7. The over-current protection device of claim 1, wherein the polymeric current-sensitive layer further comprises talc of 10% to 13% by weight.
